(19) United States
(12) Patent Application Publication
(10) Pub. No.: US 2026/0114455 A1
(43) Pub. Date: Apr. 30, 2026

(54) CARRIER MATERIAL FOR LIVING BIOLOGICALS AND PREPARATION THEREOF

(71) Applicant: HOCHSCHULE BIELEFELD - UNIVERISTY OF APPLIED SCIENCES AND ARTS, Bielefeld (DE)

(72) Inventors: Linda MUSKAT, Bielefeld (DE); Anant PATEL, Bielefeld (DE)

(21) Appl. No.: 18/841,446

(22) PCT Filed: Feb. 28, 2023
(86) PCT No.: PCT/EP2023/054929

§ 371 Date: Aug. 26, 2024

(30) Foreign Application Priority Data
Feb. 28, 2022 (EP) 22159230.6

(51) Int. Cl. A01N 63/30; A01N 25/04; A01P 1/00; A01P 3/00; A01P 5/00; A01P 7/04; A01P 13/00; A01P 17/00; A01P 19/00; A01P 21/00

(52) U.S. Cl. CPC A01N 63/30; A01N 25/04; A01P 1/00; A01P 3/00; A01P 5/00; A01P 7/04; A01P 13/00; A01P 17/00; A01P 19/00; A01P 21/00

(57) ABSTRACT

A carrier material for living biologicals contains a biodegradable and water absorbing material or polymer combined with an oil and an olcogelator and living biologicals. The material can be used for plan protection and other applications.

The present invention relates in a first aspect to a carrier material for living biologicals, said carrier material contains biodegradable and water-absorbing material or polymer, combined with an oil and an oleogelator. In another aspect, the present invention relates to a carrier material combined with the living biologicals, the carrier material contains biodegradable and water-absorbing material or polymer, an oil combined with living biologicals. Furthermore, kits of parts for carrier material are provided as well as the use of carrier material for living biologicals in different types of applications including plant protection etc.

### BACKGROUND TO THE INVENTION

Biological materials, such as beneficial microorganisms, including bacteria, fungi and nematodes, are useful alternatives to conventional agents for improvement and/or maintenance for soil and plant health, including the control of pests.

The biological material may be provided in various stages, namely, as living material, including spores, conidia, resting spores, hyphae, bacteria, eggs or other stages of development, but also in other forms including attenuated or killed biological materials. Living biological materials are sensitive to environmental exposure. Typically, a main problem of using biological materials is the problem of desiccation as well as killing by environmental conditions, including UV radiation. That is, the sensitivity of biological materials to environmental conditions is crucial in some aspects and, thus, application of the biological materials for example to be introduced into soil and for storing purposes is limited.

Moreover, for active agents based on chemical compounds, like chemical pesticides in agriculture or in other applications which are released into the environment and being harmful to the environment, more restrictions are given by the state and national regulations. Thus, biological materials also known as biocontrol agents, in particular, living biologicals are more and more in the focus in various applications including agricultural applications. That is, the biocontrol agents including fungi, bacteria, and nematodes are of interest for biologically based pesticides etc. For example, for combatting mosquitos and ticks, bacteria as well as useful fungi are more and more important as biocides in various applications.

A number of different formulations and carrier materials as well as encapsulation techniques have been described to allow application of the biological materials or biocontrol agents as living biologicals protected against negative environmental influences, thus, maintaining the efficacy and efficiency as well as the shelf storage of the components accordingly.

A main problem for effective employment of biocontrol agents is often the insufficient availability of fluids including water, since the presence of water is important to maintain viability of the living biologicals, otherwise, deficiency in water availability or fluid availability adverse the activity. Namely, it is necessary to provide a suitable microclimate for the biocontrol agents.

For example, entomophthoralean fungi have a high potential for insect pest control due to their high host specificity, their fast speed-to-kill and the ability to cause epizootics. Despite their potential, no Entomophthorales-based biocontrol product has been established and commercialized for practical use so far. Previous studies have shown that dissatisfactory water availability of to date existing formulations under field conditions is a main limiting factor of conidial discharge and germination of entomophthoralean species and the lack of success in field trials e.g. Hajek et al., Carruthers R I, Soper R S (1990), Environ Entomol 19(1):85-90. For some species, germination only occurs in presence of free water or at least under humidity conditions between 90 and 100% RH. Efficient sporulation of infective conidia is obligatory for successful application of an entomophthoralean fungus in pest control strategies.

Pandora sp. nov. inedit (ARSEF 13372) was isolated from an infected psyllid collected in a Danish pear orchard by Jensen A H et al., (2018), Mitt Dtsch Ges Allg Angew Entomol 21:283-286 and is currently under description as a new species. The pathogenicity of Pandora sp. nov. against several psyllid species: Cacopsylla pyri, C. pyricola, C. picta, C. mali, C. pruni and Trioza apicalis under laboratory conditions has been shown. A suitable fermentation medium and process with potential for mass-production of Pandora sp. nov. was established. Further, the conversion of Pandora sp. nov. into an easily applicable form was realized by encapsulation of hyphal biomass in Ca-alginate capsules additionally providing nutrients for improved sporulation capacity. With this formulation, the two target psyllid species C. picta and C. pyri were successfully infected by Pandora sp. nov. inedit and killed with a mortality up to 89%, Muskat L C et al., (2022), Pest Manag Sci 78(3):991-999.

In the literature, various approaches have been described to improve water capacity of the biocontrol agents and, in particular, increasing the storage stability as well as the viability after application. For example, the development of superabsorbent materials (or superabsorber) or polymers have been described. These materials are described as allowing storage of a multitude of water while allowing sustained or delayed release of the water. Superabsorbents are broadly used in various fields including sanitary products, like nappy and sanitary napping but also for improving the water capacity of soil in agriculture, for example, providing water to crops, while saving water at the same time.

Conventional superabsorbents are typically petroleum based and harmful, partly cancerous, due to acrylic acids, which are applied in form of polyacrylates, e. g., the product STOCKOSORB®. However, these conventional superabsorbents are not biologically degradable and, thus, environmental pollution in form of plastic materials takes place. Hence, there is an ongoing development of the use of renewable raw material, in particular, renewable material which is biodegradable in the environment.

Hence, there is a need for suitable carrier materials for living biologicals applicable in the environment allowing biodegradation of the same after use. Further, the carrier material must provide a suitable microclimate allowing the living material present to exercise its bioactive and biocontrol role.

### DESCRIPTION OF THE PRESENT INVENTION

In a first aspect, the present invention relates to a carrier material for living biologicals, whereby the carrier material contains biodegradable and water-absorbing material or polymer, oil and oleogelator.

Namely, the present inventors have recognized that the carrier material according to the present invention allows to improve the water supply and maintenance of sufficient humidity for prolonging life of living biologicals and for development of living biologicals, like for improving sporulation of the living biologicals accordingly. That is, the carrier material provides the required microclimate for prolonging life of the bioactive agents.

That is, sufficient sporulation over a long time is required to combat and control pests. Depending on the biological material, the particular stage of development for allowing infection and control of the pests is required. For example, for Pandora sp. nov., a novel entomophthoralean species of the genus Pandora, as biocontrol agent for psyllid pest control requires a formulation that secures the virulence of the fungus when applied against the target insects. In particular, the provision of living biological biocontrol agents, like the entomopathogenic fungi, but also of other living biologicals based on bacteria, nematodes etc., over a prolonged time is required to improve its beneficial effects. The parameters relevant for allowing sufficient virulence and efficiency include the shelf life, growth and sporulation duration as well as the applicability of the living biologicals.

For a lot of biological agents, namely, living biological agents, a sufficient humidity is required. Namely, it is necessary to provide a suitable microenvironment or micro-climate prolonging life of the biologicals. In particular, since application of the living biologicals is in nature, the material used for application should be biocompatible and biodegradable to allow release into the environment.

In this connection, the term “microclimate” refers to the climate immediately surrounding the biologicals. The microclimate or microenvironment is of particular relevance for the life time and development of the living biologicals accordingly.

The present invention, namely, the carrier material described herein, allows to increase applicability, growth and sporulation duration as well as intensity after field application. That is, the material according to the present invention provides the necessary microclimate for the biologicals. The specific combination of the biodegradable and water absorbing material or polymer with the oil and the oleogelator enables to provide sufficient humidity for e. g. sporulation of fungi. Depending on the living biological, these living biologicals may be present in the carrier material as such or may be present encapsulated in suitable materials.

In an aspect of the present invention, the carrier material for living biologicals according to the present invention is a material wherein the biodegradable polymer is alkylcellulose, in particular, methylcellulose or carboxymethylcellulose, or starch derivatives. These compounds are known having high water absorbent properties.

Alternatively, the living biologicals may be provided as a further material, like being encapsulated or being present in fast rehydrating layers. Useful materials will be described below. That is, the material for encapsulation or including the living biologicals must be designed in a way to allow release of the virulent stages of the respective biologicals over a prolonged time, accordingly. For example, in case of fungi, conidia will be released into the environment, thus, infecting the pest accordingly.

Moreover, the oil present in the carrier material enabling delayed release of water is a plant-based oil or an animal based oil, mineral oil or microbial oil. In particular, with respect to the biocompatibility, it is desired that the oil is a plant-based oil which can be biodegraded easily in the environment and, typically, the degradation products are naturally occurring in nature.

The term “plant-based” and “vegetable” are used herein interchangeably.

In a further aspect, the oleogelator is a plant-based wax, like candelilla wax, lecithin, phytosterol, like sitosterol, oryzanol, alkylcellulose, chitin, protein, shellac, monoglyceride, sterole and so on.

Oleogelators are known in the art and are described e.g. in WO 2021/013917 A1. Namely, the term “oleogelator” as used herein, refers to a molecule being aimed to increase viscosity of non-polar liquids by building three-dimensional structures. That is, these molecules cause gelling of the non-polar liquid while increasing the viscosity thereof. That is, an oleogelator is a gelling agent of oleogels. Unless otherwise indicated, an oleogelator is one oleogelator or a combination of any two or more oleogelators.

The term “oleogel” as used herein, refers to a hardened or solidified non-polar, typically liquid, solidified by gelling with an oleogelator.

As used herein, the term “non-polar liquid” refers to a liquid wherein the molecules have not the properties of a permanent dipole, that is, the charge distribution is homogenic in the molecule. Non-polar compounds are soluble in non-polar solvents like benzol but not in polar solvents like water.

As used herein, the term “comprising” or “containing” includes the embodiments of “consisting of”. Unless otherwise indicated, the term “a” or “the” refers to one or more thereof.

In an embodiment of the present invention, the oleogelator is at least one oleogelator selected from the group of alkylcellulose, wax, in particular, plant-based wax, steorole, fatty alcohols, fatty acids, wax acids, wax ester, fatty acid ester, isoprene derivatives, mono-di- and/or tri-glyceride, lecithine, stearate, proteins, lignines, gelatine, polysaccharides, polysaccharides like chitin derivatives etc. The oleogelator may comprise at least one compound, in an embodiment at least two compounds are present.

In an embodiment, the alkylcellulose is an ethylcellulose. In case of a combination of oleogelators, an embodiment thereof is the use of alkylcellulose, like ethylcellulose, in combination with a plant-based wax. In a preferred embodiment, the combination is a combination of ethylcellulose with canauba wax or a combination of ethylcellulose with candililla wax. Other plant-based waxes preferred according to the present invention are berry wax, myrthe wax, bee wax, etc. These waxes will modulate the polarity and/or the release accordingly. Moreover, they can modulate the surface of the obtained gel formulation. Ethylcellulose and alkylcellulose in general are polymeric oleogelators which allow to regulate gelling. Depending on the oleogelator selected and the non-polar liquid selected as well as their proportions, the viscosity of the gel can be adjusted. Depending on the building of the 3D network, the viscosity may increase until solidification of the gel.

In an embodiment, the oleogelator is a combination of ethylcellulose and plant-based wax. Particularly preferred are a combination of ethylcellulose with plant-based wax including canauba wax and candelilla wax, whereby the amount is 0.1 to 20% and the ratio is 0.01 to 0.1:2 weight-%.

Suitable unpolar liquids include plant-based, animal-based, microbial or mineral oils. Suitable material include sunflower oil, canola oil, sesame oil, olive oil, linseed oil, corn oil, palm oil, soybean oil, cocoa butter, fish oil, kerosene oil, rhizinus oil, nut oil, coconut oil, peanut oil, cottonseed oil, but also saturated monounsaturated and polyunsaturated fatty acids (PUFAs), such as arachidonic acid and fatty alcohols, such as octyldodecanol, or also co-solvents such as hexane, xylene, etc.

In an embodiment of the present invention, the carrier material for living biologicals is a material comprising carboxymethylcellulose as water absorbent polymer, a plant-based oil in combination with a plant-based wax as oleogelator. Thus, it is possible to provide simple bio-compatible and bio-degradable material applicable in nature.

Particular combinations for the carrier material depend on the living biological provided. With entomopathogenic fungi (EPF) actively discharging infective spores, the position of the formulated fungus on the surface is preferable. In the case of organisms that have to be digested by the target insect, an incorporation of the living biological into the carrier material is preferable.

As mentioned above, the living biological, e. g. suitable as a biocontrol agent, is supplied in a fast rehydrating layer or encapsulated in a fast degrading capsule. Suitable capsules and suitable encapsulation methods include known encapsulation methods with biocompatible and biodegradable components. Suitable components are for example the well-known calcium alginate encapsulation or wettable powders.

In an embodiment, the fast rehydrating layer is composed of xanthan. Other suitable materials include: cellulose and its derivatives, such as methylcellulose, carboxymethylcellulose, croscarmellose, cellulose fibres, starch and its derivatives, gellan gum, alginate, agar, pullulan, hygroscopic salts and composites thereof.

E.g. the fast rehydrating layer is provided in form of a xerogel or aerogel. As used herein, the term “xerogel” refers to highly porous material formed from a gel by drying and the term “aerogel” refers to porous material formed from a gel, in which the liquid component for the gel has been replaced with a gas without significant collapse of the gel structure.

That is, the present carrier material is a material suitable as a kind of superabsorbent and in a substitute of superabsorbent material described in the art. Namely, the carrier material representing a kind of superabsorbent material allows to establish the required microclimate accordingly. The biodegradable superabsorbent material allows an application in nature. In particular, the carrier material according to the present invention is suitable for agriculture application.

The agriculture application includes application in soil, in particular, in dry soil as well as in the above-ground or air application. This is particularly of interest in view of the change of the climate. The climate change leads to changes of the humidity of the soil and a drying out of soils the yield in agriculture. To improve the same, improved material is required providing suitable microclimate to enable the use of the respective biological agents accordingly.

In addition, in an embodiment wherein the carrier material is formed as a paste, in particular, as a sticky paste, the paste can be applied to the above ground parts of the plants allowing the application of the biologicals useful as biological agents in the seniti of the plants.

In an embodiment, the carrier material for living biologicals according to the present invention comprises the hydrogel layer absorbing water, whereby said hydrogel layer absorbs water more rapidly than the carrier material containing the biodegradable and water absorbing material or polymer, oleogelator and oil forming a water absorbing layer according to the present invention. In an aspect, the two types of materials, the hydrogel and the carrier material as defined, form a bigel formulation when mixed with each other.

In another embodiment, the carrier material for living biologicals according to the present invention comprises besides the carrier material containing the bio-degradable and water absorbing material or polymer, oil and oleogelator as defined herein, and, optionally, the hydrogel layer, additionally a water barrier layer. This water barrier layer is a layer allowing to delaminate the carrier material from other surfaces. In addition, the water barrier layer prevents run off of water from the carrier material accordingly. In an embodiment, the water barrier layer is composed of a bio-degradable material, in particular, the water barrier essentially consists of insoluble alkylcellulose, in particular, ethylcellulose.

Specific embodiments of the carrier material for living biologicals will be described further in the examples below.

In a further aspect the present invention relates to a carrier material with (containing) living biologicals. This carrier material containing the living biologicals comprises a bio-degradable and water absorbing material or polymer, an oil and living biologicals.

In an aspect, the living biologicals are microorganisms. In particular, these living biologicals are suitable living biocontrol agents. These living biocontrol agents are suitable for combatting pests or suitable weed control compositions. In an embodiment, the living biologicals are fungi, microsporidia, microalgae, arthropods, arthropod eggs or nematodes. For example, the living biologicals are fungi, including entomopathogenic fungi. In particular, preferred fungi include entomophthoralean species, including Pandora and other suitable Entomophthorales. For example, these entomophthoralean species are suitable for pest control strategies of psyllids or aphids in orchards.

For example, in an embodiment of the present invention of the carrier material containing living biologicals, the living biologicals are present in granules or capsules or beads. Typically, these granules, capsules or beads are composed of bio-degradable polymers. Suitable polymers include alginate, thus, the living biologicals are present in calcium alginate capsules or the like. Other suitable granules, capsules or beads include: spray dried living biologicals, oil-based formulations, including emulsions in which the cells are incorporated, electrospun fibers, silicates, clay or other stone based carrier materials on which the organisms are adsorbed, living biologicals coated on seeds, granules, capsules or beads made of starch, lignin, agar, gellan gum, milk powder, protein based materials, such as chitin/chitosan, casein, waste materials from wood or food industry and so on.

In an embodiment, the biologicals are provided in capsules, for example by capsules composed of biodegradable polymers, like Ca-alginate capsules and are applied onto a paste formed by the carrier material according to the present invention. A typical example is outlined below.

Moreover, the carrier material containing living biologicals according to the present invention as well as the carrier material for living biologicals according to the present invention may comprise additionally other components. These other components may include additional components including: preservatives, drying protectants, surfactants, fillers, pigments, vitamins, antioxidants, UV-active compounds, fungicides, bactericides, herbicides, semiochemicals, sugars, proteins, aminoacids, salts, permeation enhancer/suppressants, sticker/adhesives and so on.

The carrier material containing living biologicals or the carrier material for living biologicals may be provided dependent on the application the type or form of the carrier material containing living biological is selected. For example, in agriculture application, the material with living biological is suitable for spraying, spreading and application by hand. The material may be in form of a paste or granules or the like. For spreading and application e. g. by spreader useful for fertilizer spreader, the material with living biologicals may be in form of granules. The form is selected in view of the type of application desired.

In a further embodiment, kits of parts for a carrier material according to the present invention are provided. The kits of parts comprise a mixture of the components of the water absorbing layer in dry form. In an embodiment, namely, wherein the carrier material is a carrier material containing living biologicals, the kit of parts comprises further the living biologicals to be included into the carrier material accordingly.

The carrier material according to the present invention, namely, the carrier material for living biologicals according to the present invention or the carrier material containing the living biologicals according to the present invention are particularly useful in pest control field. For example, the material may be used as a plant protection agent, as insecticide, fungicide, bactericide, nematicide, herbicide, rodenticide, plant strengthener, insect repellent or attractant, insect deterrent or insect arrestant as well as an adhesive.

The skilled person is well aware of the suitable type of application in field application. The type of application may be in the soil but may also be in the air. For example, the material may be adhered to parts of plants allowing the pest control accordingly. As said, it is required to provide optimal humidity conditions for allowing development and discharge of e. g. conidia in case of fungi to improve efficiency of pest infection. That is, suitable virulence of the fungus is necessary to demonstrate suitable mortality rates with the pest.

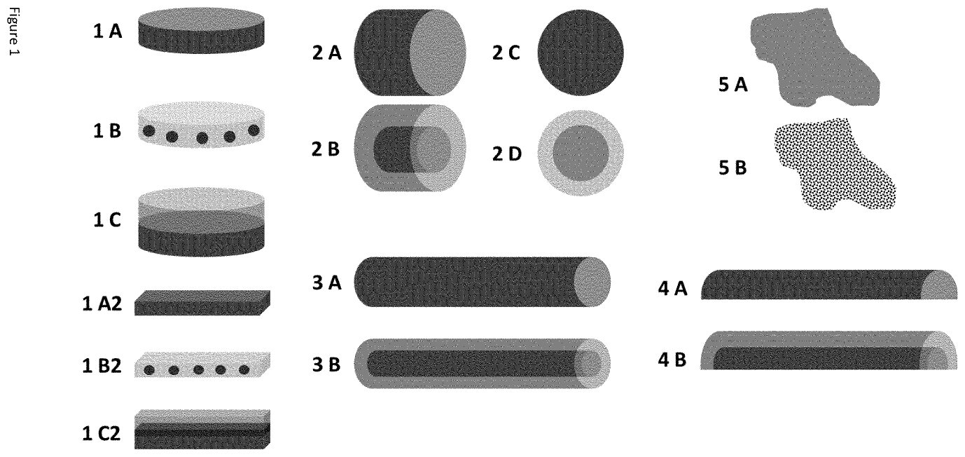

As shown in FIG. 1, various embodiments of the carrier material is possible, in particular being in form of a two-layered or three-layered embodiment. The first layer representing the biodegradable and water absorbing material or polymer is shown in black or dark grey. The second layer of the fast rehydrating material termed the hydrogel layer is shown in light grey.

Embodiments include: A film (1A & 1A2), a film with incorporated water retarding areas (1B & 1B2) or a layered film (1C & 1C2), a granule, spheronized granule or bead (2A-D), a fiber (3A/B), a paste (4A/B) for direct extrusion at the application side or a sprayable fluid (5A), or bigel (5B). that forms droplets after spray application. The bigel in 5b is formed by emulsifying the carrier material according to the present invention with the hydrogel, e.g. in form of a xerogel or aerogel.

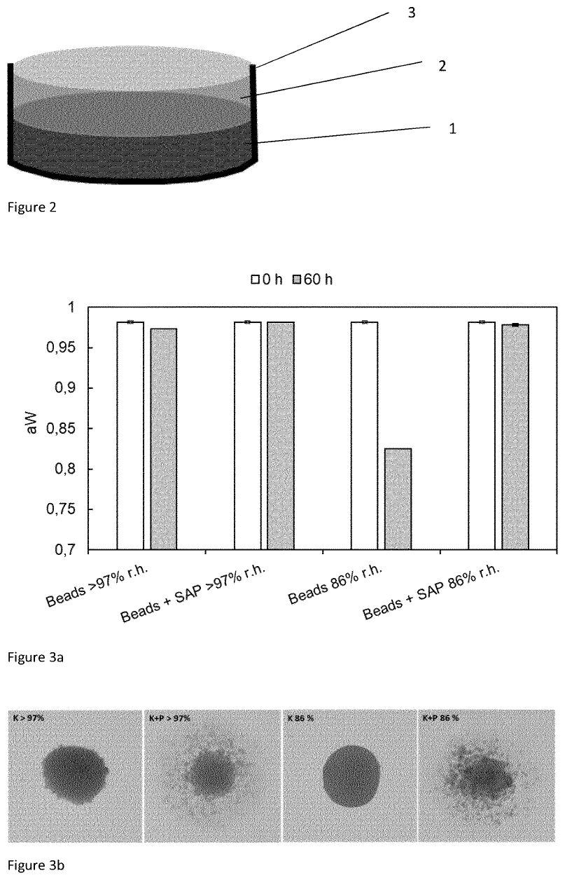

FIG. 2 is an example of a 3 layered carrier material. In the middle the biodegradable and water absorbing material or polymer (dark grey) (1) with the second layer of the fast rehydrating material termed the hydrogel layer in light grey (2) on top and the water barrier layer at the bottom (black) (3).

The present invention will be described further by way of examples without limiting the same thereto.

In the following, an example of a pasteous carrier material is provided:

### EXAMPLE 1

Swelling paste - POSSIBLE COMPOSITION

| | |
|---|---|
| Plant-based oil (sunflower oil, sesame oil) | 10-90% |
| Natural waxes (plant-based waxes, like candellila wax or carnauba wax) | 0-20% |
| Carboxymethylcellulose or other water soluble cellulose derivates | 10-90% |

For example, the mixing ratio is 1:1 of the oily phase with the carboxymethylcellulose or, in case a
wax is present, of the oil and wax to carboxymethylcellulose
The mixed components can be stored dry
Before/during application (or processing e.g. by extrusion to granules) to be supplemented by
aqueous phase (in the monolayer version only water) or hydrogel layer (e.g. xanthan, +cellulose
fibers), namely by 10-100 times the amount (w/w).
Preparation of the pasted carrier material can be conducted as follows::
1. The plant-based oil is provided adding the wax thereto and heating said mixture under
steering above the melting point of the wax and mixing the wax into the oil
2. Thereafter, the carboxymethylcellulose is added to the oil-wax-mixture and mixing the same
to obtain an oleogel
3. Cooling the same and further processing for storage
4. Depending on the presence or absence of other layers (hydrophilic layer, water barrier layer),
the process is continued by preparing a aqueous phase (in case of no other layer water) or a
second layer for overlaying the above oleogel and overlaying this with the second fast
hydrating layer or mixing the same with the aqueous phase either consisting solely of water
or the fast hydrating layer, mixing by steering and homogenizing it by introducing heat or
other type of energy, allowing swelling for at least 12 to 24 hours of the material
5. The material obtained may be used further by direct application or may be preportionated for
later use. Alternatively, it may be extruded into granules for storage.

### EXAMPLE 2

| | |
|---|---|
| Plant-based oil (like sesame oil) | 48.5% |
| Natural wax (like plant-based wax, candelilla wax or carnauba wax) | 1.5% |
| Carboxymethylcellulose (e.g. WALOCEL ™ CRT 60000 GA (DuPont)) | 50% |

This composition may be dried for storage if desired.
The mixture may be coated or overlayed with an aqueous phase consisting of xanthan (2%) in water
in amount of layer 1:layer 2 = 1:14
Preparation:
1. The plant based oil is provided with a heatable stirring device whereby the candelilla wax
(1.5%; W/W) is added, the mixture is heated under stirring at 80° C, the meltingpoint of the
candelilla wax, and the melted wax is mixed with the oil.
2. The carboxymethylcellulose (50% by weight) is added to the oil-wax-mixture and mixed to
form the desired gelled paste material after cooling to room temperature
3. Cooling the same, optionally in a form containing a water barrier material, like ethylcellulose,
and cooling to room temperature.
4. Optionally covering the same with a hydrogel as described in example 1, e.g. xanthan (2%)
hydrogel and allowing swelling for at least 12 to 24 hours of the material.

### EXAMPLE 3

### Improved Water Retention to Enable Fungal Sporulation

The carrier material for living biologicals obtained in example 2 has been used to examine water availability, namely, the material has been placed on the ceramic plate in an exsiccator in which the relative room humidity was maintained by distilled water or lowered by saturated salt solutions placed in the basin below the material.

As demonstrated, even at lower relative humidity of 86%, sporulation can be observed when using the paste material as carrier material for the sporulation of the isolate provided in capsules. The data provided shows the results for the encapsulated material (Pandora sp. nov. ARSEF13372) alone (Beads) as well as combined with the carrier material according to the present invention (Beads+SAP) at relative humidity's above 97% and at 86%. It is known that sporulation of the Pandora isolates occurs only at very high humidity, typically, above 97% relative humidity. Hence, as demonstrated, the carrier material according to the present invention surprisingly allows sporulation even at relative humidity's of lower percentage, here 86% relative humidity. Moreover, the water activity (a_{W}) remains high as shown in FIG. 3. Water activity (a_{W}) is defined as the vapor pressure of water in a system after equilibration divided by that of pure water at the same temperature. Water activity is equal to equilibrium relative humidity divided by 100. a_{W} correlates with the proportion of water efficiently available for biological systems, including microbial cells and is often referred to as the “free” or “available water” in a system.

The water activity (a_{W} value) of the modified media was determined using a water activity meter (LabMASTER-aw, Novasina AG, Lachen, Switzerland) at 25° C.

Thus, the carrier material according to the present invention allows sporulation of the Pandora isolate at least for 60 hours at non saturated relative humidity conditions, here 86% relative humidity. Moreover, it has been observed that the conidia germinate, mycelial growth can be observed and formation of conidiophores producing new conidia occurs.

### Materials & Methods

### Chemicals

Chemicals were acquired either from Carl Roth GmbH (Karlsruhe, Germany) or VWR International GmbH (Darmstadt, Germany). Carboxymethylcellulose was purchased from Dow (Dow Chemical Company, Midland, MI, USA) and Xanthan gum from DuPont (Du Pont de Nemours GmbH, Neu-Isenburg, Germany). Concentrations are given as (w/w), unless otherwise stated.

### Fungal Isolate

The Pandora sp. nov. inedit. isolate originated from an infected Cacopsylla pyri specimen collected in a Danish pear orchard (55° 50′24.3″N 12°33′46.5″E) and was named KVL 16-44. The strain is deposited in the USDA Agricultural Research Service Collection of Entomopathogenic Fungal Cultures (Ithaca, NY) as ARSEF 13372. The fungus is under description (inedit.) and will here be referred to as Pandora sp. nov.

### Cultivation of Pandora sp. nov.

Pandora sp. nov. was grown on solid medium adapted from Hajek et al. (2012) composed of 4.0% glucose, 2.0% casein and 2.0% agar (Saboraud Dextrose Agar (SDA)) supplemented with 20% of a mixture of 60% egg yolk and 40% fresh skimmed milk (SDAME) on Petri dishes (diameter 90 mm) sealed with Parafilm® and incubated at 18° C. in the dark. To prevent loss of virulence, the fungus was frequently and at least after the fourth subculture infecting the host insect C. pyri and thereafter reisolated.

Submerged cultures of Pandora sp. nov. were grown in liquid medium. Briefly, the pre-culture was composed of fresh skimmed milk (10%; w/w), in which the fungus grew for 48 hours. The main culture, which was inoculated by 10% (v/v) of the pre-culture and was composed of glucose (26.6 g×L⁻¹), sodium chloride (NaCl; 10 g×L⁻¹), yeast extract (3.33 g×L⁻¹), skimmed milk powder (3.33 g×L⁻¹) and a low-cost protein hydrolysate from animal by-products (3.33 g.×L⁻¹), in which the culture was grown for further 48 h at the same conditions as the pre-culture. All media components were dissolved in ultrapure water and separately autoclaved for 6 min at 121° C. and 2 bar.

### Preparation of Capsules

All experimental steps were carried out under sterile conditions and all solutions and components were autoclaved for 6 min at 121° C. and 2 bar, unless otherwise stated. Briefly, finely dispersed hyphae of Pandora sp. nov. were collected from liquid culture by centrifugation (4700 g; 15 min; 18° C.). Sodium alginate was dissolved in ultrapure water to a final concentration of 3.0% and autoclaved for 6 min at 121° C. The encapsulation suspension was composed of sodium alginate, heat-sterilized native corn starch, pre-dissolved skimmed milk powder (4%, w/w) and hyphal material of Pandora sp. nov. (10%). For capsule formation, the solution was dripped into a stirred (250 rpm) calcium chloride solution (0.1 M) by using a syringe with a cannula (diameter 2.1×0.8 mm,). Capsules were kept in the solution under stirring for 20 min and were subsequently washed with ultrapure water for 1 min.

### Preparation of the Water Retaining Paste Formulation

Candelilla wax (CLW; Kahlwax GmbH & Co. KG, Trittau, Germany; batch code: 10-1185; 1.5% w/w) was mixed with sesame oil (RAPUNZEL NATURKOST GmbH, Memmingen, Germany) and maintained under stirring at 100° C. for 20 min for sterilization. Carboxymethylcellulose (WALOCEL CRT 60000 GA 07, Dow Chemicals, Batch code: F294H89011, MW: 60000; CMC) was heat-sterilized at 100° C. overnight in an oven. CMC was added to the hot wax oil mixture at a ratio of 1:1 and dispersed by a spatula while cooling the mixture to room temperature for solidification. Xanthan gum (GRINDSTED® Xanthan 80, A45100, Du Pont, Neu-Isenburg, Germany; batch code: 4453438167; 2%; w/w) was dispersed in ultra-pure water and autoclaved at 121° C. and 2 bar for 21 min. 0.5 g of the oil-wax-CMC mixture was spread over the bottom of a Petri dish (Ø=35 mm) by aid of a spatula and overlayered by 7.5 g of the xanthan gum gel. The Petri dishes were closed with the Petri dish lid, sealed with Parafilm® and maintained at 5° C. in the fridge for at least 24 h and stored there until use.

### Sporulation Experiments Under Non-Saturated Humidity Conditions in the Laboratory

One capsule per dish was placed on the surface in the center of each paste filled in the Petri dishes. Capsules without the paste were fixed with a drop of pure xanthan gel (2%) on the Petri dish bottom. The dishes were fixed at a height of 3 cm above Petri dishes (Ø=35 mm) filled with SDS for collection of conidia. The formulations were incubated at 30-40% room humidity and 21-24° C. for 12 days. Room humidity and temperature was recorded with a datalogger (EBI 20-TH 1, Ebro Electronic™, Xylem Analytics Germany Sales GmbH & Co. KG, Weilheim, Germany) throughout the experiment. The SDS was replaced every 24 h. The collected conidia were quantified in a Fuchs-Rosenthal hemocytometer with 6 replicates per sample.

### Semi-Field Sporulation Trial Considering Cardinal Direction

Net cages, 175×175×175 cm each (Aerarium Nets, Bern, Switzerland) with sun and rain shelters were built on experimental field at the Julius Kühn-Institut (Dossenheim, Germany). One potted pear tree (Pyrus communis L. cv. ‘Williams Christ’ grown on cv. P. communis ‘Kirchensaller Mostbirne’ rootstock) was placed in each net cage. Before starting the experiment, the capsules were pre-incubated on the water retaining paste formulation in Petri dishes (Ø=35 mm) for three days. The dishes containing the paste formulation and 20 pre-incubated capsules were fixed to the top of the potted pear tree with the dish opening facing downwards. Four petri dishes were fixed to each tree, considering in each case the different cardinal directions. To determine sporulation, glass slides (Thermo Scientific, Braunschweig, Germany) were placed at regular intervals of 5, 20, and 40 cm from each sporulation source. The experiment was conducted from 14.09.2020 to 17.09.2020. Humidity and temperature were recorded with data loggers (DS1923-F5, Hygrochron Temp/Luftfeuchte, Elektronik Fuchs, Weingarten, Germany) throughout the experiment. After 72 hours, the glass slides were recollected. The conidia attached to slides were scanned and counted with a digital microscope (VHX 7000, Keyence® Deutschland, Neu-Isenburg, Germany).

### Statistical Analysis

Statistical analysis of mycelial growth and sporulation of Pandora sp. nov. was carried out using the software SPSS Statistics V25.0 (SPSS, Chicago, IL). All data are given as mean values±standard deviations (SD). Data for conidial discharge were checked for normality and homogeneity of variance using Shapiro-Wilk and Levene test. Mean numbers of discharged conidia were tested for significant differences by one-way ANOVA followed by a Tukey post hoc range test and Bonferroni correction. If the criteria for variance homogeny and normal distribution were not met, data have been calculated by nonparametric Kruskal-Wallis test followed by Bonferroni for multiple comparisons with one treatment. The number of discharged conidia over time was compared with a repeated measures ANOVA, with time and treatment as independent variables. The sphericity of the matrix assumption was assessed with the Mauchly sphericity test. If the outcome of the test was significant, the Greenhouse-Geisser adjustment was used to correct for violations of sphericity. The level of significance was set to p<0.05. All experiments were carried out with at least 5 replicates.

Sporulation of Pandora sp. Nov. Under Non-Saturated Humidity Conditions in Laboratory Experiment

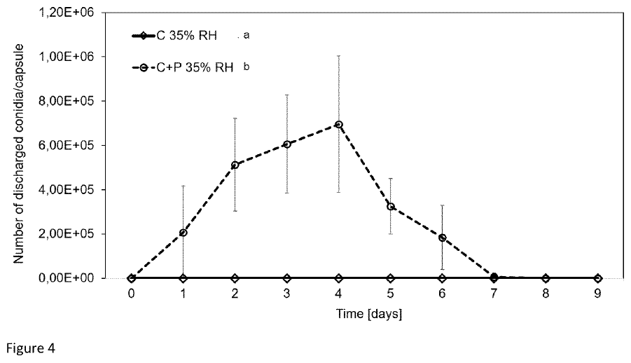

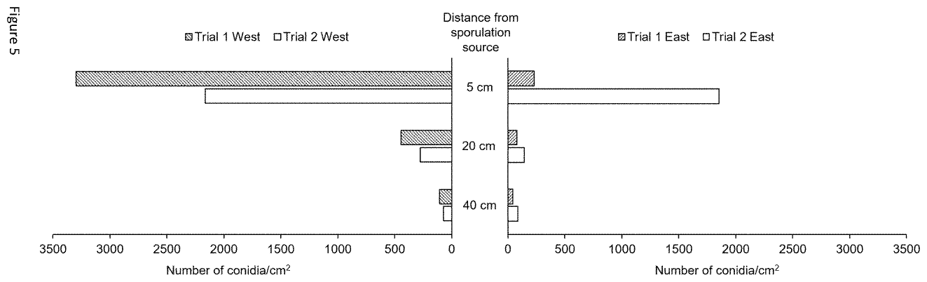

Co-application of the capsules with the paste formulation supported growth and sporulation of encapsulated Pandora sp. nov. under non-saturated humidity conditions in the laboratory for 7 days at a room humidity between 30 and 40% (FIG. 4). Compared to raw capsules, which dried under the present conditions and did not release any conidia, significantly more conidia were discharged by encapsulated Pandora sp. nov. when co-applied with the paste formulation (F_{1,58}=734,951; p<0.001; Games-Howell).

A peak sporulation event was observable at day 4 with the highest conidial numbers of 6.96×10⁵ (±3.08×10⁵) conidia/capsule on day 4. The total number of conidia released from the capsules during the 7 days within sporulation was detectable was 1.79×10⁷ (±3.21×10⁶).

FIG. 4 shows the sporulation of Pandora sp. nov. from capsules (C) and from capsules co-applied with a biobased superabsorbent past-type formulation (C+P) under non-saturated humidity conditions (30-40% RH) within 9 days. Different letters in the legend indicate significant differences according to RM-ANOVA and Games-Howell correction at p<0.01. Means±SD, n=5.

### Sporulation Under Semi-Field Condition

In the semi-field trial conducted in September 2020, capsules co-applied with the water retaining paste formulation were fixed at the top of pear trees. Mean temperature during the experiment was 19.5° C. (min 11° C.; max 28° C.) and mean humidity was 64% (min 32%; max 100%). Pandora sp. nov. was able to sporulate under these application conditions. Sporulation was determined by collection of conidia on glass slides fixed at 5, 20 and 40 cm vertical distance from the sporulation source. Most conidia of Pandora sp. nov. were collected at the lowest distance, but conidia were observable on all glass slides (FIG. 5). At the lowest distance of 5 cm, 2730 (±566) conidia per cm² were counted. At 20 cm distance 362 (±85) conidia per cm² were found and at 40 cm distance 90 (±16) condia/cm² were counted (FIG. 5). A comparison of sporulation rates considering cardinal directions shows that less conidia were discharged on the sun facing side in the east than on the sun-averted side in the west (FIG. 5).

FIG. 5 provides the number of conidia discharged during 72 h and collected on glass slides fixed at different distances from the Petri dish containing the paste and the Pandora sp. nov. capsules as sporulation source

In order to compare the results from the listed studies with those from the present one, where the water activity value was investigated instead of RH, the comparability needs to be explained: the definition of a_{W} is a_{W}=pₛₐₘₚₗₑ/p_{water}, where pₛₐₘₚₗₑ is the partial vapor pressure in equilibrium with the tested material or solution and p_{water} is the partial vapor pressure of pure water at the same temperature. In the present study, glycerol was selected as a_{W} modifier, as it is known for its a_{W} stability under different temperatures. The relative humidity of air in equilibrium with a material or solution is also called the Equilibrium Relative Humidity (ERH) expressed in %. It is equal to water activity according to ERH=a_{W}×100%. Therefore, the results from studies investigating RH are comparable to the present study investigating a_{W}. Here it is demonstrated that sporulation by Pandora sp. nov. can be enabled under non-saturated humidity conditions by co-application with a specific water absorbing biobased polymer formulation according to the present invention. The findings present for the first time a strategy of using biobased polymers of huge water absorbency to enable efficient sporulation of an entomophthoralean fungus in the field.

Hence, the suitability of the carrying material according to the present invention on living biologicals is demonstrated.

1. A carrier material for living biologicals, comprising:
i) bio-degradable and water-absorbing material or polymer,
ii) oil, and
iii) oleogelator.

2. The carrier material for living biologicals according to claim 1 wherein the bio-degradable and water absorbing material or polymer is an alkylcellulose.

3. The carrier material for living biologicals according to claim 1, wherein the oil is selected from the group consisting of a plant-based oil, an animal-based oil, a mineral oil, and a microbial oil.

4. The carrier material for living biologicals according to claim 1, wherein the oleogelator is selected from the group consisting of a plant-based wax, a lecithin, a phytosterol an alkylcellulose, a fatty acid, a fatty alcohol, a wax acid, a wax ester, a fatty acid ester, an isoprene derivative, a monotriglyceride, a ditriglyceride, a stearate, a shellac, a protein, and a chitin.

5. The carrier material for living biologicals according to claim 1, wherein the biodegradable and water absorbing material or polymer is or comprises carboxymethylcellulose, the oil is a plant-based oil, and the oleogelator is a plant-based wax.

6. The carrier material for living biologicals according to claim 1 further comprising a water barrier layer.

7. The carrier material for living biologicals according to claim 6, wherein the water barrier layer is composed of a bio-degradable material.

8. The carrier material for living biologicals according to claim 1, further comprising a xerogel of a hydrogel layer, whereby said hydrogel layer absorbs water more rapidly than the carrier material which forms a water absorbing layer.

9. The carrier material for living biologicals according to claim 8 comprising the water absorbing layer and the hydrogel in a form of a bigel formulation.

10. A carrier material with living biologicals, wherein the carrier material comprises i) bio-degradable and water-absorbing material or polymer, and ii) an oil, and wherein the living biologicals are present in and on the carrier material.

11. A carrier material with living biologicals comprising:
a carrier material according to claim 1; and
living biologicals associated with the carrier material.

12. The carrier material containing living biologicals according to claim 10, wherein the living biologicals are present on a surface or within the water absorbing layer, and/or, wherein the living biologicals are within a hydrogel layer.

13. The carrier material with living biologicals according to claim 10 wherein the living biologicals are microorganisms.

14. The carrier material with living biologicals according to claim 10 wherein the living biologicals are present in granules or capsules or beads composed of bio-degradable.

15. The carrier material for living biologicals according to claim 1 wherein any the carrier material is in a form of a paste, bead, granule, powder, liquid, emulsion, or gel.

16. The carrier material according to claim 1 configured to have a water activity of at least 95%.

17. Kit of parts for a carrier material according to claim 1 comprising the bio-degradable water absorbing material or polymer, oil and, optionally the oleogelator, in dry form, and optionally a xerogel forming a hydrogel.

18. The kit of parts according to claim 1 comprising further living biologicals present in granules or capsules or beads.

19. A method of using the carrier material for living biologicals according to claim 1, comprising supporting living biologicals on the carrier material for use in an agricultural application.

20. The method of claim 19 wherein the agricultural application is selected from the group consisting of a plant protection agent, an insecticide, a fungicide, a bactericide, a nematicide, a herbicide, a rodenticide, a plant strengthener, an insect repellent, an insect attractant, an insect deterrent, an or insect arrestant, and an adhesive.

21. The method of claim 20 wherein the carrier materials is present in a form of a paste with living biologicals present in granules or capsules or beads composed of bio-degradable polymers.

22. The method of claim 19 wherein in performing the agricultural application the carrier material is applied into soil, and/or attached to plants, or is applied in an above ground application.

23. The carrier material with living biologicals of claim 13 wherein the microorganisms are entomopathogenic fungi.
